(19) United States
(12) Patent Application Publication
(10) Pub. No.: US 2026/0307390 A1
(43) Pub. Date: Oct. 8, 2026

(54) INSPECTION METHOD AND COATING APPARATUS

(71) Applicants: Kenji KAMEI, Tokyo (JP); Takahide MAEDA, Kanagawa (JP); Kento AOKI, Kanagawa (JP); Takahiko SUGIURA, Kanagawa (JP)

(72) Inventors: Kenji KAMEI, Tokyo (JP); Takahide MAEDA, Kanagawa (JP); Kento AOKI, Kanagawa (JP); Takahiko SUGIURA, Kanagawa (JP)

(21) Appl. No.: 19/478,846

(22) PCT Filed: Apr. 30, 2024
(86) PCT No.: PCT/IB2024/054168

§ 371 Date: Oct. 27, 2025

(30) Foreign Application Priority Data
May 12, 2023 (JP) 2023-079432

(51) Int. Cl. B41J 2/165; B41J 2/21

(52) U.S. Cl. CPC B41J 2/16579; B41J 2/2114

(57) ABSTRACT

An inspection method comprising discharging a transparent ink onto a transparent substrate; emitting ultraviolet rays from a first surface of the transparent substrate; detecting ultraviolet rays transmitted through the transparent substrate, from a second surface opposite to the first surface of the transparent substrate; and determining a discharge state of the discharging based on the detecting of the ultraviolet rays.

### TECHNICAL FIELD

The present embodiment relates to an inspection method and a coating apparatus.

### BACKGROUND ART

In an image forming apparatus that forms an image on media or in a coating apparatus that performs coating by discharging a liquid such as ink from a recording head, inspecting the state of discharge of the liquid from the recording head is known.

For example, a technology is disclosed in which ink discharge failure is detected by mixing, with a transparent ink, a phosphor that emits light by means of ultraviolet rays, and irradiating the ink with ultraviolet rays to cause the ink to emit light (see, for example, Patent Literature (PTL) 1).

### SUMMARY OF INVENTION

### Technical Problem

The present applicant has intensively studied whether or not the discharge state from liquid discharging means for discharging transparent ink may be inspected using a simpler method.

An object of the present embodiment is to provide an inspection method and a coating apparatus that enable a state of liquid discharge from liquid discharging means to be inspected using a simple method.

### Solution to Problem

An inspection method comprising discharging a transparent ink onto a transparent substrate; emitting ultraviolet rays from a first surface of the transparent substrate; detecting ultraviolet rays transmitted through the transparent substrate, from a second surface opposite to the first surface of the transparent substrate; and determining a discharge state of the discharging based on the detecting of the ultraviolet rays.

### Advantageous Effects of Invention

The present embodiment enables the state of discharge of the liquid from the liquid discharging means to be inspected using a simple method.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a diagram illustrating an embodiment of a coating apparatus that implements an inspection method according to the present embodiment.

FIG. 2 is a block diagram illustrating a configuration example of the coating apparatus illustrated in FIG. 1.

FIG. 3 is a diagram illustrating a configuration example of a supply mechanism included in the coating apparatus illustrated in FIG. 1.

FIG. 4 is a perspective diagram illustrating a configuration example of a head included in the coating apparatus illustrated in FIG. 1.

FIG. 5 is a cross-sectional view of the head taken along plane S1 in FIG. 4.

FIG. 6 is a block diagram illustrating an example of a functional configuration of a controller included in the coating apparatus illustrated in FIG. 1.

FIG. 7 is a flowchart illustrating an example of a coating operation by the coating apparatus illustrated in FIG. 1.

FIG. 8 is a diagram illustrating an example of arrangement of an inspection mechanism in the coating apparatus according to the present embodiment.

FIG. 9 is a diagram illustrating an example of the transparent medium illustrated in FIG. 8.

FIG. 10 is a diagram to illustrate an operation in the configuration illustrated in FIG. 8.

FIG. 11 is a diagram illustrating an example of a state in which transparent ink is discharged from the heads of the coating apparatus.

FIG. 12 is a diagram illustrating an example of arrangement of a transparent medium in the inspection method according to the present embodiment.

FIG. 13 is a diagram illustrating an example of an inspection pattern printed on a transparent medium.

FIG. 14 is a flowchart to illustrate an example of an inspection method according to the present embodiment.

FIGS. 15A to 15C are diagrams illustrating examples of ultraviolet rays patterns detected by a camera.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, the embodiment of the present embodiment will be described with reference to the drawings. However, the following embodiment exemplifies an inspection method for embodying the technical concepts of the present embodiment, and the present embodiment is not limited to the embodiment hereinbelow. In addition, the dimensions, materials, shapes, relative arrangements, and the like of the components described in the embodiments are, unless otherwise specified, not intended to limit the scope of the present embodiment only to such dimensions, materials, shapes, relative arrangements, and the like, and are merely illustrative examples. The sizes, positional relationships, and the like of the components illustrated in the drawings may be enlarged in order to clarify the description. In the following description, the same names and reference signs indicate the same or similar members, and thus detailed descriptions thereof will be omitted as appropriate.

### Configuration Example of Coating Apparatus

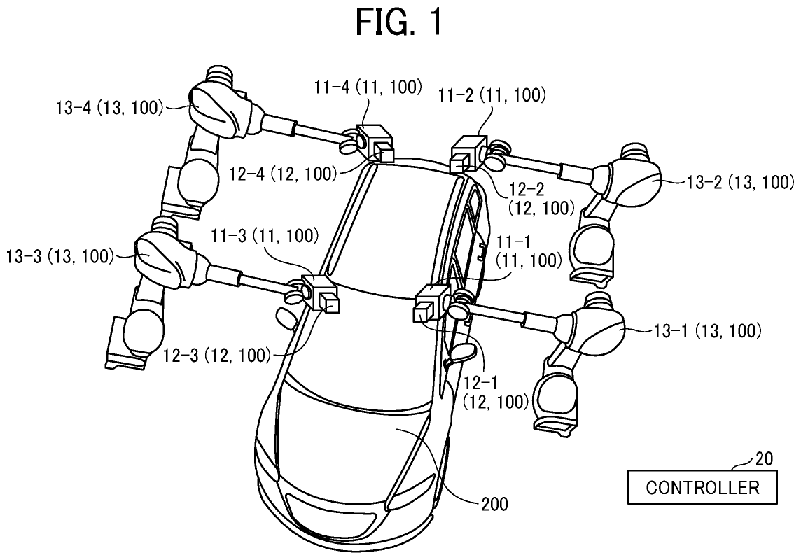

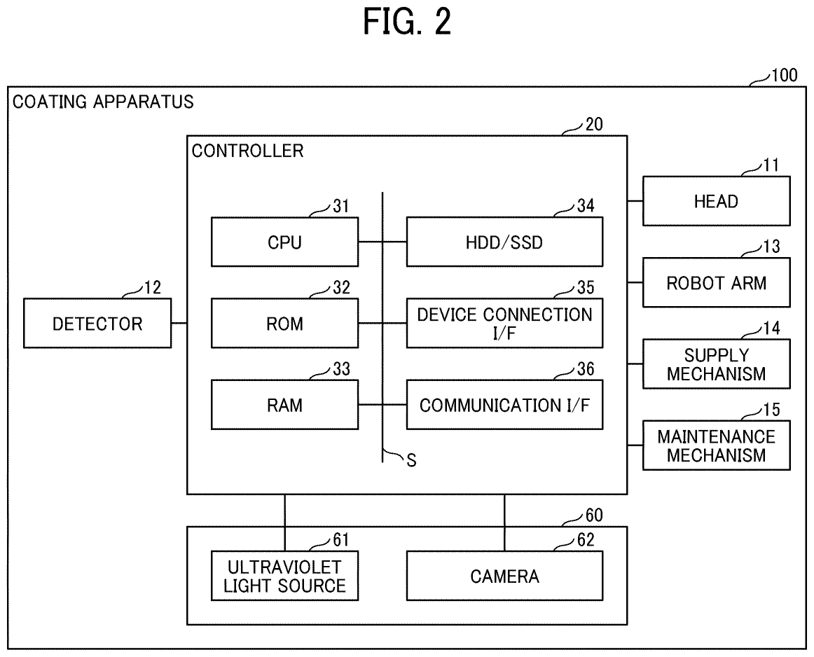

FIG. 1 is a diagram illustrating an embodiment of a coating apparatus that implements an inspection method according to the present embodiment. FIG. 2 is a block diagram illustrating a configuration example of the coating apparatus 100 illustrated in FIG. 1.

As illustrated in FIG. 1, the coating apparatus 100 according to the present embodiment applies a liquid discharged by a liquid discharge method to an object 200. The liquid discharge method by the coating apparatus 100 is, for example, a continuous discharge method. The continuous discharge method includes a valve method for controlling discharge by controlling an operation of a valve body to open and close a nozzle, a continuous method for charging ink particles continuously discharged from the nozzle, using a deflection electrode to bend the charged ink particles and spray the charged ink particles on a printing surface, and the like. The liquid applied to the object 200 adheres to the object 200 after drying.

As illustrated in FIGS. 1 and 2, the coating apparatus 100 includes four heads 11, four detectors 12, four robot arms 13, a supply mechanism 14, a maintenance mechanism 15, an inspection mechanism 60, and a controller 20. Under the control of the controller 20, the coating apparatus 100 drives the robot arms 13 holding the four heads 11 on the basis of the predetermined shape data of the object 200 and the information regarding the three-dimensional positions of the three or more feature points outputted from each of the four detectors 12. The coating apparatus 100 changes relative positions and relative inclinations of the four heads 11 and the object 200 by driving the four robot arms 13, and discharges liquid from each of the four heads 11 to the object 200. The coating apparatus 100 applies the liquid discharged from the four heads 11 to the object 200 to coat the object 200. Further, the coating apparatus 100 uses the inspection mechanism 60 to inspect the state of liquid discharge from the four heads 11.

The four heads 11 are an example of the liquid discharging means in the present embodiment. The four heads 11 include a head 11-1, a head 11-2, a head 11-3, and a head 11-4. The respective configurations of the four heads 11 may be the same or different. In the present specification, it is assumed that the configurations of the four heads 11 are the same. The number of heads 11 included in the coating apparatus 100 is not limited to four, and may be appropriately changed according to the size, shape, and the like, of the object 200.

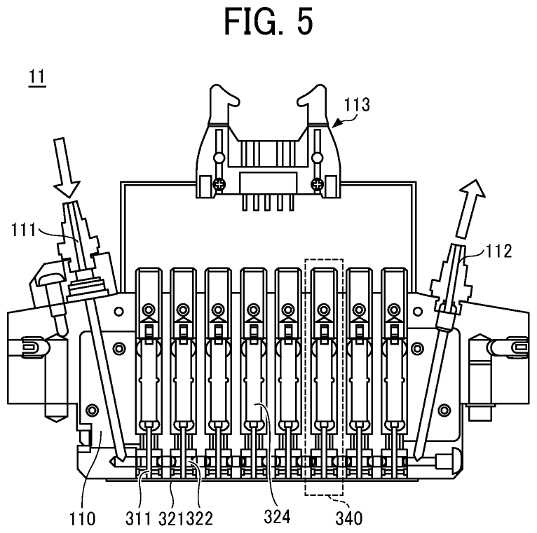

The four heads 11 each discharge liquid to the object 200 from nozzles. For example, the head 11 includes a nozzle surface where a plurality of nozzles for discharging liquid are formed, and is disposed such that the nozzle surface faces the surface to be coated of the object 200. The four heads 11 apply, to the object 200, the liquid discharged from each of the plurality of nozzles. The configurations of the heads 11 will be described in detail separately also with reference to FIGS. 4 and 5.

Each of the four heads 11 may discharge liquid to mutually different regions in the object 200. The liquid discharged from each of the four heads 11 may be discharged to a partially overlapping region. Each of the four heads 11 discharges liquid to mutually different regions of the object 200, and thus coating is performed in a short time even when the size of the object 200 is large.

The four detectors 12 include a detector 12-1, a detector 12-2, a detector 12-3, and a detector 12-4. The configurations of the four detectors 12 may be the same or different. In the present specification, it is assumed that the configurations of the four detectors 12 are the same. The number of detectors 12 included in the coating apparatus 100 is not limited to four, and may be appropriately changed according to the number of heads 11 and the like.

Each of the four detectors 12 outputs feature point information, which is information relating to three-dimensional positions of three or more feature points of the object 200. Each of the four detectors 12 includes, for example, a stereo camera. The stereo camera includes a plurality of cameras, and acquires a distance image of the object 200 by a triangulation method on the basis of the parallax between images photographed by each of the plurality of cameras. The stereo camera outputs the distance image to the controller 20 as the feature point information.

The four robot arms 13 include a robot arm 13-1, a robot arm 13-2, a robot arm 13-3, and a robot arm 13-4. The configurations of the four robot arms 13 may be the same or different.

In the present specification, it is assumed that the configurations of the four robot arms 13 are the same. The number of robot arms 13 included in the coating apparatus 100 is not limited to four, and may be appropriately changed according to the number of heads 11 and the like.

The four robot arms 13 are an example of a movement mechanism that moves the heads 11 relative to the object 200. Each of the four robot arms 13 is disposed near the object 200. Here, the four robot arms 13 are arranged around the object 200, each holding a head 11 and a detector 12, and move the respective heads 11 and respective detectors 12 relative to the object 200. As long as the heads 11 are moved relative to the object 200, the movement mechanism is not limited to being the robot arm 13, and may include a combination of a plurality of linear motion stages or the like.

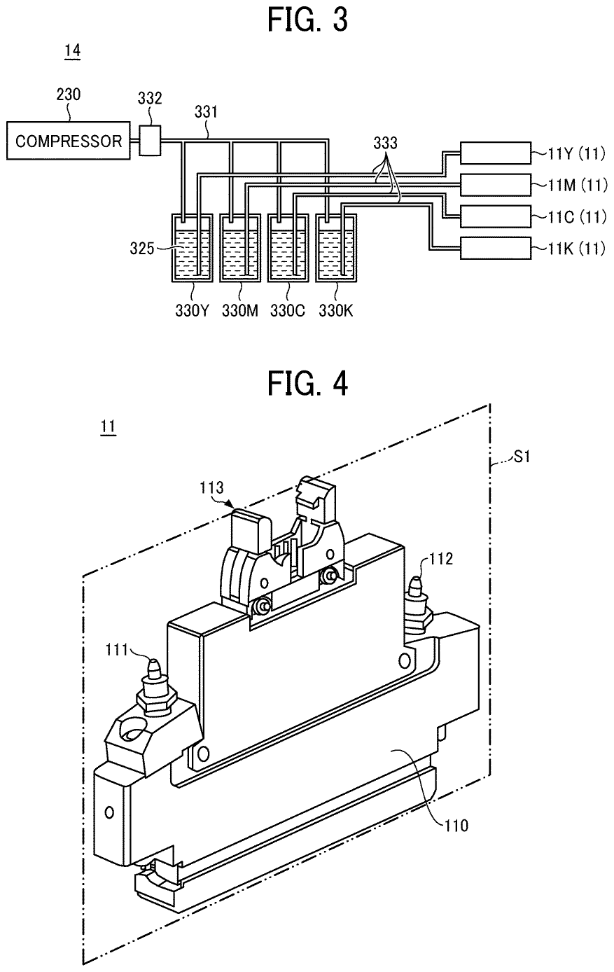

In FIG. 2, the supply mechanism 14 supplies liquid to each of the four heads 11. The configuration of the supply mechanism 14 will be described in detail separately with reference to FIG. 3.

The maintenance mechanism 15 maintains the state of liquid discharge by each of the four heads 11. The maintenance mechanism 15 includes a wiper that wipes the nozzle surface of each of the four heads 11, a suction pump that sucks liquid from the inside of each of the four heads 11, and the like. The maintenance mechanism 15 uses a wiper, a suction pump, or the like to remove thickening fluid and foreign matter that adheres to the nozzle surface, or thickening fluid and foreign matter present inside the heads 11. The maintenance mechanism 15 removes the thickening fluid, foreign matter, and the like, to reduce discharge abnormalities such as non-discharge, discharge bend, and discharge speed variation in each of the four heads 11 and maintain the discharge state of each of the four heads 11 in a normal state.

The inspection mechanism 60 includes an ultraviolet light source 61 and a camera 62. The ultraviolet light source 61 serves as an emitting means in the present embodiment. When inspecting the state of liquid discharge from the four heads 11, the ultraviolet light source 61 irradiates the transparent medium, onto which the transparent ink has been discharged from the heads 11, with ultraviolet rays from one surface side. The camera 62 serves as detecting means in the present embodiment, and detects ultraviolet rays by photographing the transparent medium irradiated with the ultraviolet rays from the other surface side. As the camera 62, a general ultraviolet sensor may be used. Here, “transparent” means that the transmittance is 60% or more with respect to visible light (wavelength 400 through 800 nm) and less than 60% with respect to ultraviolet rays (wavelength 200 through 400 nm).

In FIGS. 1 and 2, the controller 20 controls the discharge of liquid by the heads 11 and the operation of the robot arms 13 on the basis of shape data of the predetermined object 200, and feature point information outputted from the detectors 12. In addition, the controller 20 controls the operation of the inspection mechanism 60.

The controller 20 includes, for example, a processor or an electrical circuit or the like which is mounted on an electrical circuit board. The controller 20 is coupled to each of the four heads 11, the four detectors 12, the four robot arms 13, and the inspection mechanism 60 so as to be able to communicate therewith in a wired or wireless manner. The controller 20 receives detection signals from the four detectors 12 and transmits control signals to the four heads 11 and the four robot arms 13. Furthermore, the controller 20 transmits a control signal to the inspection mechanism 60 and receives the ultraviolet rays detection results of the inspection mechanism 60.

An arrangement position of the electrical circuit board on which the controller 20 is mounted is arbitrary, and the electrical circuit may be arranged in a position remote from the heads 11 or the like.

As illustrated in FIG. 2, the controller 20 includes a central processing unit (CPU) 31, a read only memory (ROM) 32, a random access memory (RAM) 33, a hard disk drive (HDD)/solid state drive (SSD) 34, a device coupling interface (I/F) 35, and a communication I/F 36. These controller components are electrically coupled to each other via a system bus S.

The CPU 31 uses the RAM 33 as a work area, and controls the whole operation of the controller 20 by executing processing defined in a program stored in the ROM 32.

The ROM 32 is a nonvolatile memory that stores a program for executing control such as recording operations in the CPU 31, and other fixed data.

The RAM 33 is a volatile memory that temporarily stores various data used for liquid discharge by the heads 11, driving of the robot arms 13, and the like, detection results by the detectors 12 and the inspection mechanism 60, and the like.

The HDD/SSD 34 is a nonvolatile memory that stores shape data of the object 200, image data such as a picture and characters drawn on the object 200, and the like.

The device coupling I/F 35 is an interface to be communicably coupled to each of the heads 11, the detectors 12, the robot arms 13, the supply mechanism 14, the maintenance mechanism 15, and the inspection mechanism 60.

The communication I/F 36 is an interface for communicably coupling an external device such as a host personal computer (PC) to the controller 20.

In addition to the foregoing, the coating apparatus 100 may include a display unit that displays a settings screen for setting conditions for liquid coating by the coating apparatus 100 and so forth, a touch panel that receives operations of the coating apparatus 100, operating parts, which are operation input devices such as a keyboard and a mouse, and the like.

### Configuration Example of Supply Mechanism 14

FIG. 3 is a diagram illustrating a configuration example of the supply mechanism 14 included in the coating apparatus 100 illustrated in FIG. 1.

Each of the four heads 11 includes a head 11Y that discharges yellow (Y) liquid, a head 11M that discharges magenta (M) liquid, a head 11C that discharges cyan (C) liquid, and a head 11K that discharges black (K) liquid.

The heads 11 may further include a head that discharges other liquids such as a head that discharges an overcoat liquid and a head that discharges a primer liquid or a white liquid in addition to the heads that discharge the liquids of the respective colors. The supply mechanism 14 supplies liquid of each color to the heads 11.

The supply mechanism 14 includes a liquid tank 330 as a sealed container that stores the liquid 325 of each color discharged from the heads 11. The liquid tank 330 and the injection port (supply port) of the heads 11 are coupled to each other through a tube 333 so that liquid flows therethrough.

Meanwhile, the liquid tank 330 is coupled to the compressor 230 via a pipe 331 including an air regulator 332, and the compressor 230 supplies pressurized air. As a result, the pressurized liquid 325 of each color is supplied to the injection port of the heads 11, and the coating apparatus 100 discharges the liquid 325 from the nozzle of the heads 11.

Furthermore, in the present embodiment, the liquid tank 330 storing the transparent ink to be supplied to the heads 11 is provided as the liquid tank.

### Configuration Example of Heads 11

FIG. 4 is a perspective diagram illustrating a configuration example of the head 11 included in the coating apparatus 100 illustrated in FIG. 1. FIG. 5 is a cross-sectional view of the head 11 taken along plane S1 in FIG. 4.

As illustrated in FIGS. 4 and 5, the head 11 has a plurality of discharge modules 340 arranged in one row or a plurality of rows in a housing 110.

The head 11 includes a supply port 111 and a collection port 112. The supply port 111 supplies pressurized liquid from the outside to the discharge module 340, and the collection port 112 discharges liquid that has not been discharged to the outside. The housing 110 includes a connector 113.

As illustrated in FIG. 5, the discharge module 340 includes a nozzle plate 321 including a nozzle 311 that discharges liquid, a channel 322 that is in communication with the nozzle 311 and that supplies the pressurized liquid, and a piezoelectric element 324 that drives a needle-shaped valve body that opens and closes the nozzle 311.

The nozzle plate 321 is joined to the housing 110. Further, the channel 322 is a channel common to the plurality of liquid discharge modules 340 in the housing 110. The coating apparatus 100 supplies the pressurized liquid from the supply port 111 through the channel 322 and discharges the liquid from the recovery port 112. During the period in which the liquid is discharged to the object 200, the liquid need not be temporarily discharged from the recovery port 112 in order not to lower the discharge efficiency of the liquid from the nozzle 311.

### Functional Configuration Example of Controller 20

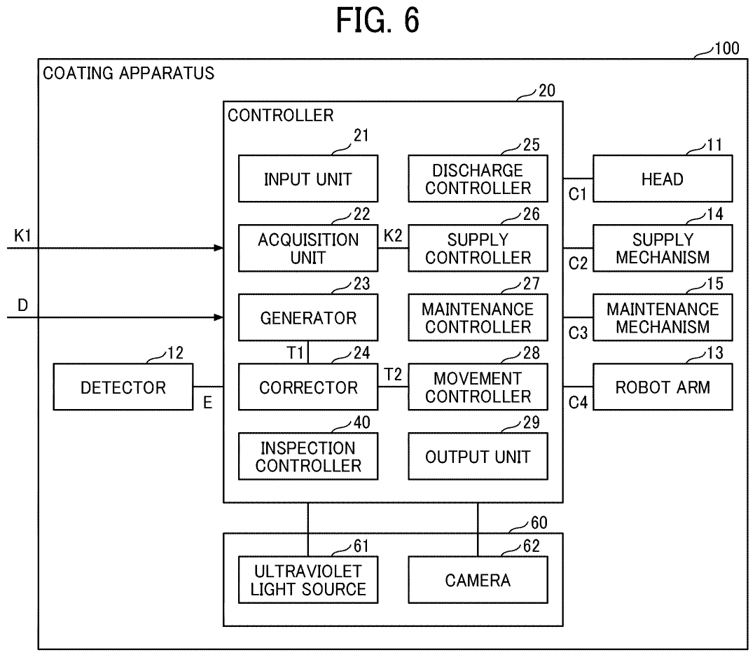

FIG. 6 is a block diagram illustrating an example of a functional configuration of a controller 20 included in the coating apparatus 100 illustrated in FIG. 1.

The controller 20 includes an input unit 21, an acquisition unit 22, a generator 23, a corrector 24, a discharge controller 25, a supply controller 26, a maintenance controller 27, a movement controller 28, an output unit 29, and an inspection controller 40.

The functions of the input unit 21 and the output unit 29 are implemented by the device coupling I/F 35, the communication I/F 36, and the like, in FIG. 2.

Each function of the acquisition unit 22, the generator 23, the corrector 24, the discharge controller 25, the supply controller 26, the maintenance controller 27, the movement controller 28, and the inspection controller 40 is implemented by the CPU 31 deploying, in the RAM 33, a program stored in the ROM 32 and executing the processing defined in the program.

Components other than the controller 20, such as the heads 11, may have at least some of the functions of the controller 20. In addition, at least some of the functions of the controller 20 may be implemented by distributed processing between the controller 20 and components other than the controller 20.

The input unit 21 controls communication with an external device to input, from the external device, the shape data D of the object 200 and the object information K1 which is information indicating the object 200. Furthermore, the input unit 21 inputs the feature point information E from the detectors 12 by controlling communication with the detectors 12. The input unit 21 also receives inspection results from the inspection mechanism 60.

The acquisition unit 22 acquires coating color information K2, which is information related to the colors of liquid to be coated on the object 200, on the basis of the object information K1 inputted from the external device via the input unit 21, and outputs the acquired coating color information K2 to the supply controller 26.

On the basis of the shape data D of the object 200 inputted from the external device via the input unit 21, the generator 23 generates the relative movement path information T1, which is information on the relative movement path for the robot arms 13 to move the heads 11 relative to the object 200. The generator 23 outputs generated relative movement path information T1 to the corrector 24.

The relative movement path signifies a path through which the heads 11 pass on the object 200 while changing the relative positions thereof relative to the object 200. The heads 11 may change the relative inclination relative to the object 200 according to the shape of the object 200 for each relative position with respect to the object 200. In a case where the relative inclination of the heads 11 with respect to the object 200 is changed, the relative movement path signifies a path through which the heads 11 passes on the object 200 while changing the relative position and the relative inclination with respect to the object 200.

The corrector 24 corrects the relative movement path information T1 generated by the generator 23 on the basis of the feature point information E inputted from each of the plurality of detectors 12 via the input unit 21. The corrector 24 outputs corrected path information T2, which is information on a corrected relative movement path, to the movement controller 28.

On the basis of the feature point information E, the corrector 24 detects a three-dimensional deviation of the position and inclination of the conveyed object 200 relative to the shape data D. The three-dimensional deviation of the position and inclination of the object 200 relative to the shape data D corresponds to information regarding the position and inclination of the object 200.

The corrector 24 corrects the relative movement path information T1 according to the detection result of the three-dimensional deviation with respect to the shape data D of the position and inclination of the object 200 to acquire the corrected path information T2. The corrector 24 outputs the acquired corrected path information T2 to the movement controller 28. The coating apparatus 100 moves the heads 11 relative to the object 200 according to the auxiliary path information T2. Thus, the coating apparatus 100 performs coating by three-dimensionally aligning the object 200 and the nozzles in the heads 11.

The discharge controller 25 outputs a discharge control signal C1 via the output unit 29 to control discharge of liquid from the plurality of heads 11. The discharge controller 25 controls, for example, selection of a nozzle that discharges liquid among the plurality of nozzles included in each of the plurality of heads 11, timing for discharging liquid from the nozzle, an amount of liquid discharged from the nozzle, a discharge frequency, and the like. Further, the discharge controller 25 controls the selection of the nozzle for discharging the above liquid, the timing for discharging the liquid from the nozzle, and the like on the basis of the corrected path information T2. The discharge controller 25 controls the discharge of the transparent ink from the heads 11 in accordance with a command from the inspection controller 40.

The supply controller 26 controls the supply of liquid from the supply mechanism 14 to the plurality of heads 11 by outputting the supply control signal C2 via the output unit 29. The supply controller 26 controls, for example, the selection of colors of liquid to be supplied to the plurality of heads 11, a supply timing, a supply amount, and the like. Furthermore, the supply controller 26 controls the supply of the transparent ink from the supply mechanism 14 to the heads 11 according to a command from the inspection controller 40.

The maintenance controller 27 outputs the maintenance control signal C3 via the output unit 29 to maintain the state of liquid discharge from the plurality of heads 11 from the maintenance mechanism 15. The maintenance controller 27 controls, for example, the selection of heads to be maintained among the plurality of heads 11, the timing of the maintenance operation, and the like. In addition, the maintenance controller 27 also controls the maintenance of the heads 11 in the maintenance mechanism 15 at timing in accordance with a command from the inspection controller 40.

The movement controller 28 outputs the movement control signal C4 via the output unit 29 on the basis of the corrected path information T2 to control the relative movement of each of the plurality of heads 11 with respect to the object 200 by the plurality of robot arms 13.

The inspection controller 40 serves as determining means according to the present embodiment. The inspection controller 40 controls the inspection mechanism 60 to inspect the state of liquid discharge from the heads 11.

The output unit 29 outputs the discharge control signal C1 to the heads 11 by controlling communication with the heads 11. The output unit 29 also outputs the movement control signal C4 to the robot arms 13 by controlling communication with the robot arms 13. The output unit 29 also outputs the supply control signal C2 to the supply mechanism 14 by controlling communication with the supply mechanism 14. In addition, the output unit 29 outputs the maintenance control signal C3 to the maintenance mechanism 15 by controlling communication with the maintenance mechanism 15. The output unit 29 controls communication with the inspection mechanism 60 to output a command from the inspection controller 40 to the inspection mechanism 60.

The output unit 29 corresponds to an output unit that outputs information regarding the relative movement path of the heads 11 with respect to the object 200 when acquiring the shape data D of the object 200 determined in advance and information regarding the three-dimensional positions of three or more feature points in the object 200 outputted from the detectors 12.

### Operation Example During Coating by Coating Apparatus 100

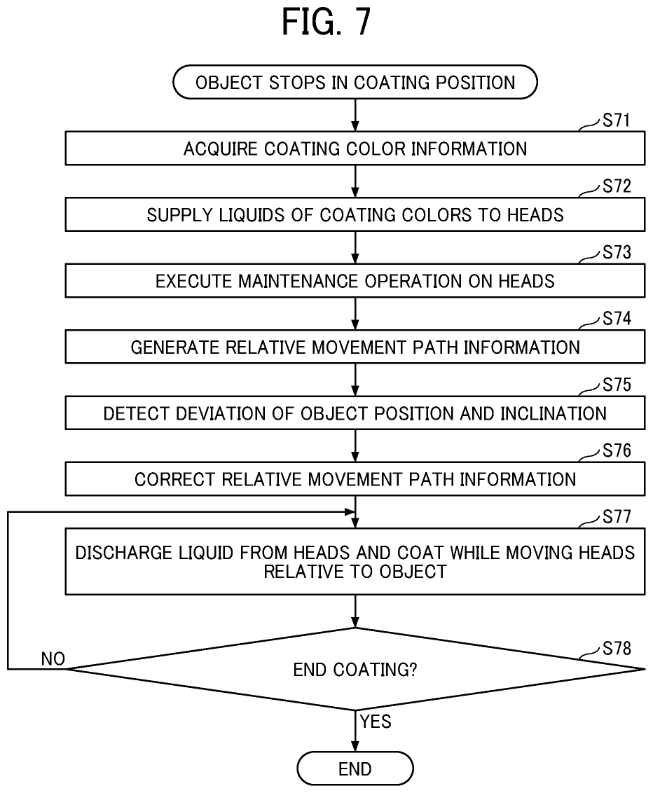

FIG. 7 is a flowchart illustrating an example of a coating operation by the coating apparatus 100 illustrated in FIG. 1.

The coating apparatus 100 starts the operation illustrated in FIG. 7 when the inspection described below is completed and the object 200 stops in a position for coating by the coating apparatus 100.

First, in step S71, the coating apparatus 100 causes the acquisition unit 22 to acquire coating color information K2, which is information related to the color of the liquid to be coated on the object 200, on the basis of the object information K1 inputted from the external device via the input unit 21. The acquisition unit 22 outputs the acquired coating color information K2 to the supply controller 26.

Subsequently, in step S72, the coating apparatus 100 controls the operation of the supply mechanism 14 by the supply controller 26, and supplies the liquids of the colors corresponding to the coating color information K2 to each of the four heads 11. In a case where the colors of the liquids to be discharged are different for each of the plurality of heads, the coating apparatus 100 may supply the liquids only to the heads that discharge the liquids of colors corresponding to the coating color information K2. In a case where the coating apparatus 100 performs coating with a plurality of colors, the coating apparatus 100 may supply liquids of different colors to each of the four heads 11.

Subsequently, in step S73, the coating apparatus 100 controls the operation of the maintenance mechanism 15 by the maintenance controller 27, and executes the maintenance operation on the four heads 11 that discharge the liquids of the colors corresponding to the coating color information K2. In a case where the colors of the liquids to be discharged are different for each of the plurality of heads, the coating apparatus 100 may execute the maintenance operation only for the heads that discharge the liquids of the colors corresponding to the coating color information K2. The maintenance operation in step S73 may also be omitted because the maintenance operation is performed in the inspection of the heads 11 described below.

Subsequently, in step S74, the coating apparatus 100 generates the relative movement path information T1 by the generator 23 on the basis of the shape data D of the object 200 inputted from the external device via the input unit 21. The generator 23 outputs generated relative movement path information T1 to the corrector 24.

Subsequently, in step S75, the coating apparatus 100 causes the corrector 24 to detect a three-dimensional deviation of the position and inclination of the conveyed object 200 from the shape data D on the basis of the feature point information E inputted from each of the plurality of detectors 12 via the input unit 21.

Subsequently, in step S76, the coating apparatus 100 uses the corrector 24 to correct the relative movement path information T1 according to the detection result of the three-dimensional deviation relative to the shape data D of the position and inclination of the object 200, and acquires the corrected path information T2. The corrector 24 outputs the acquired corrected path information T2 to the movement controller 28.

Subsequently, in step S77, the coating apparatus 100 uses the movement controller 28 to control the operations of the four robot arms 13, and performs relative movement on each of the four heads 11 while changing the relative position and the relative inclination of each of the plurality of heads 11 with respect to the object 200. Further, the coating apparatus 100 coats the object 200 by using the discharge controller 25 to control the discharge of liquid by each of the four heads 11, together with the relative movement of the heads 11. The coating apparatus 100 may perform only the relative movement of the heads 11 in areas where coating is not performed on the object 200, and need not discharge liquid from the heads 11 in these locations. Further, the coating apparatus 100 may perform coating while appropriately changing the speeds of relative movement of the heads 11 by the robot arms 13, the frequency of discharge by the heads 11, and the like.

Subsequently, in step 78, the coating apparatus 100 determines, using the controller 20, whether or not to end coating. For example, the controller 20 determines whether or not to end coating by receiving an operation input of a coating end instruction via the operating parts, determining whether or not a predetermined range for coating the object 200 has been coated, or the like.

In a case where it is determined in step S78 that the coating is not to be ended (step S78, NO), the coating apparatus 100 re-executes the operations of step S77 and subsequent steps. On the other hand, in a case where it is determined in step S78 that the coating is to be ended (YES in step S78), the coating apparatus 100 ends the operations.

As described above, the coating apparatus 100 performs coating of the object 200. When, after coating of one object 200 ends, the next object 200 is conveyed by a conveyor or the like to the coating position and stopped, the coating apparatus 100 coats the next object 200 by performing the operations of step S71 and subsequent steps.

### (Method for Inspecting Heads 11 of Coating Apparatus 100)

Hereinafter, an inspection method for inspecting the state of liquid discharge from the heads 11 in the above-described coating apparatus 100 will be described.

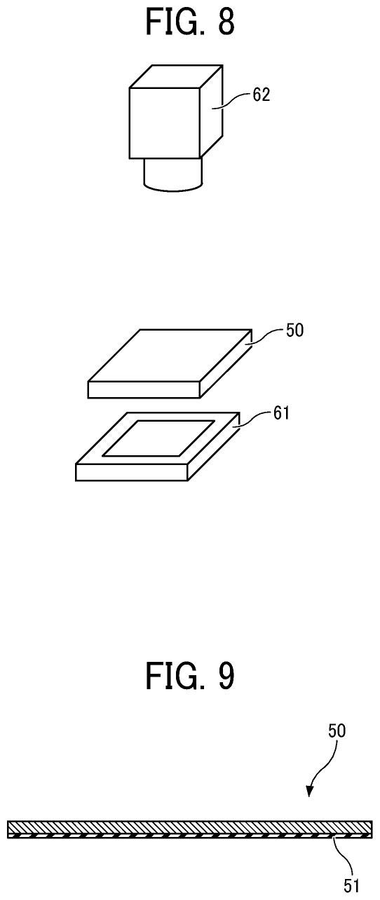

FIG. 8 is a diagram illustrating an example of arrangement of the inspection mechanism 60 of the coating apparatus 100 according to the present embodiment.

As illustrated in FIG. 8, the inspection mechanism 60 in the coating apparatus 100 according to the present embodiment performs inspection in a state where the ultraviolet light source 61 and the camera 62 are facing each other via the transparent medium 50.

The ultraviolet light source 61 is disposed on one surface side of the transparent medium 50, and irradiates one surface of the transparent medium 50 with ultraviolet rays.

The camera 62 is an example of detecting means in the present embodiment. The camera 62 detects ultraviolet rays and is disposed on the other surface side of the transparent medium 50. The camera 62 detects ultraviolet rays emitted from the ultraviolet light source 61 and transmitted through the transparent medium 50.

FIG. 9 is a diagram illustrating an example of the transparent medium 50 illustrated in FIG. 8.

The transparent medium 50 illustrated in FIG. 8 is an example of a transparent base material in the present embodiment, and includes, for example, a material such as glass or resin that transmits ultraviolet rays. As illustrated in FIG. 9, the transparent medium 50 may have an uneven shape 51 formed on one surface thereof. The uneven shape 51 is formed by grinding, blasting, or the like.

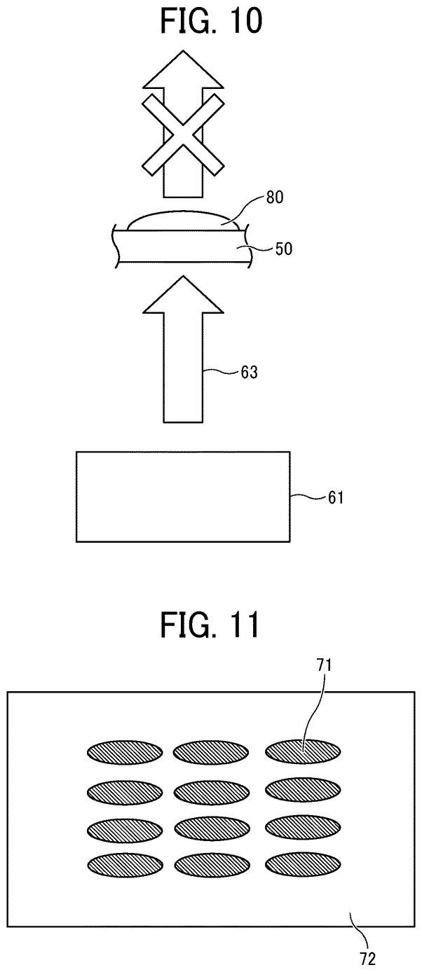

FIG. 10 is a diagram to illustrate an operation in the configuration illustrated in FIG. 8.

As illustrated in FIG. 10, the transparent ink 80 possesses the property of not transmitting the ultraviolet rays 63. Thus, as illustrated in FIG. 8, even when the ultraviolet rays 63 is emitted by the ultraviolet light source 61 from one surface side of the transparent medium 50, in a case where the transparent ink 80 adheres atop the transparent medium 50, the ultraviolet rays 63 is not transmitted, and the ultraviolet rays 63 is not detected by the camera 62.

Therefore, in the coating apparatus 100, the transparent ink 80 is discharged from the heads 11 onto the transparent medium 50. Thereafter, the ultraviolet light source 61 irradiates the transparent medium 50 with the ultraviolet rays 63 from the surface on the opposite side to the surface onto which the transparent ink 80 is discharged. The camera 62 detects ultraviolet rays from the surface of the transparent medium 50 onto which the transparent ink 80 is discharged. Thus, the state of ink discharge from the heads 11 is inspected. The ultraviolet rays 63 may be emitted from the surface of the transparent medium 50 onto which the transparent ink 80 is discharged by the ultraviolet light source 61, and the ultraviolet rays may be detected by the camera 62 from the surface of the transparent medium 50 opposite to the surface onto which the transparent ink 80 is discharged.

The transparent ink discharged onto the transparent medium may include a resin that absorbs light of wavelengths of 200 through 400 nm.

FIG. 11 is a diagram illustrating an example of a state in which the transparent ink 80 is discharged from the heads 11 of the coating apparatus 100.

As illustrated in FIG. 11, in a case where the transparent ink 80 is discharged from the heads 11 of the coating apparatus 100 onto the transparent medium 50, an adhesion region 71 to which the transparent ink 80 adheres and a non-adhesion region 72 to which the transparent ink 80 does not adhere are present on the transparent medium 50. In this state, the ultraviolet rays 63 is emitted from one surface side of the transparent medium 50 by the ultraviolet light source 61, and the ultraviolet rays 63 is detected by using the camera 62 to photograph the transparent medium 50 from the other surface side. Thereupon, in the image captured by the camera 62, the adhesion region 71 becomes dark like a shadow because the ultraviolet rays 63 is not transmitted. Meanwhile, the non-adhesion region 72 becomes bright due to the transmission of the ultraviolet rays 63. At this time, as illustrated in FIG. 9, when the uneven shape 51 is formed on one surface of the transparent medium 50, the amount of light entering the camera 62 may be made uniform by diffusing the ultraviolet rays 63 emitted from the ultraviolet light source 61. The uneven shape 51 may be formed on both surfaces of the transparent medium 50.

It is thus possible to determine the shape and presence or absence of the liquid discharged from the heads 11. In particular, it is possible to determine the shape and presence or absence of the transparent overcoat liquid discharged from the heads 11 so as to cover the coating in order to protect the coating of the vehicle body. At that time, as described above, if the transparent ink discharged onto the transparent medium includes a resin that absorbs light of wavelengths of 200 through 400 nm, the ability to protect the coated surface of the vehicle may be improved.

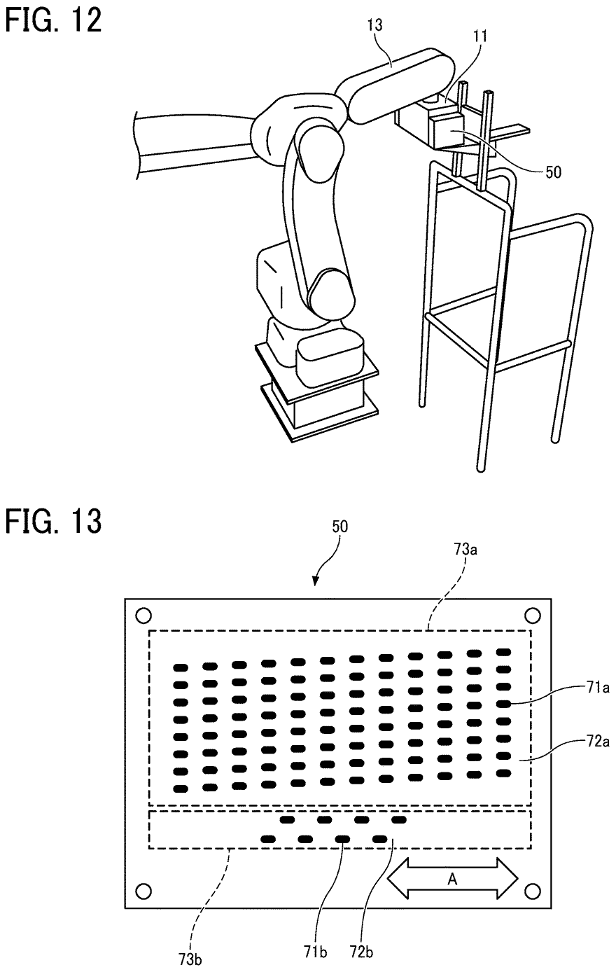

FIG. 12 is a diagram illustrating an example of arrangement of the transparent medium 50 in the inspection method according to the present embodiment.

As illustrated in FIG. 12, for example, the transparent medium 50 is disposed beside the vehicle body to be coated by the coating apparatus 100. The heads 11 are then moved to a region facing the transparent medium 50 by the robot arms 13, and the transparent ink is discharged from the heads 11 onto the transparent medium 50 to print an inspection pattern. Thereafter, as described above, the state of discharge of the ink from the heads 11 is inspected by the ultraviolet light source 61 emitting the ultraviolet rays 63 from one surface of the transparent medium 50, and by using the camera 62 to detect the ultraviolet rays from the other surface of the transparent medium 50.

FIG. 13 is a diagram illustrating an example of an inspection pattern printed on the transparent medium 50.

The head 11 according to the present embodiment includes a main head and a small head. Therefore, as illustrated in FIG. 13, the transparent medium 50 includes a main head portion 73a serving as a region for printing by the main head and a small head portion 73b serving as a region for printing by the small head. The main head portion 73a and the small head portion 73b exist to extend in parallel with each other in the printing direction A, for example. The main head portion 73a includes, so as to correspond to each nozzle constituting the main head, an adhesion region 71a to which the transparent ink adheres and a non-adhesion region 72a to which the transparent ink does not adhere. Furthermore, the small head portion 73b includes, so as to correspond to each nozzle constituting the small head, an adhesion region 71b to which the transparent ink adheres and a non-adhesion region 72b to which the transparent ink does not adhere.

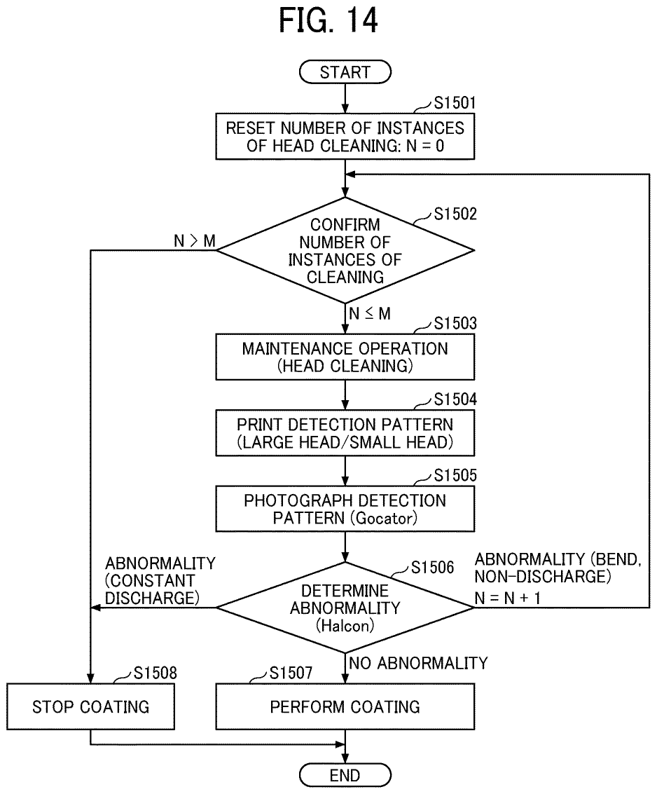

FIG. 14 is a flowchart to illustrate an example of the inspection method according to the present embodiment.

In the coating apparatus 100, the state of liquid discharge from the heads 11 is inspected before performing coating of the vehicle, for example, as described above. At that time, as illustrated in FIG. 12, the transparent medium 50 is disposed beside the vehicle body to be coated by the coating apparatus 100.

First, in step S1501, the coating apparatus 100 uses the inspection controller 40 to reset the number of instances of cleaning of the heads 11 by the maintenance mechanism 15.

Subsequently, in step S1502, the coating apparatus 100 uses the inspection controller 40 to increase, by one, the number of instances of cleaning of the heads 11 by the maintenance mechanism 15, and confirms whether the increased number of instances of cleaning exceeds a predetermined number of instances.

In a case where the increased number of instances of cleaning does not exceed the predetermined number of instances, the inspection controller 40 outputs, to the maintenance controller 27, a command to perform the maintenance operation of the heads 11 by the maintenance mechanism 15.

Then, in step S1503, the maintenance controller 27 performs a maintenance operation such as cleaning of the heads 11 by the maintenance mechanism 15.

On the other hand, in a case where the increased number of instances of cleaning exceeds the predetermined number of instances, the coating apparatus 100 stops the coating in step S1508.

Subsequently, the inspection controller 40 outputs, to the discharge controller 25, a command to discharge the transparent ink from the heads 11. Thereupon, in step S1504, the discharge controller 25 discharges the transparent ink from the heads 11 onto the transparent medium 50 to print an inspection pattern (discharge process). The transparent ink is supplied, under the control of the supply controller 26, from the liquid tank storing the transparent ink to the heads 11 to be inspected.

Subsequently, in step S1505, the coating apparatus 100 uses the inspection controller 40 to cause the ultraviolet light source 61 to emit the ultraviolet rays 63 from one surface side of the transparent medium 50 (emission step), and to detect the ultraviolet rays 63 by means of the camera 62 from the other surface side of the transparent medium 50 (detection step). For example, as described above, the ultraviolet rays 63 is emitted by the ultraviolet light source 61 from the surface side of the transparent medium 50 opposite to the surface onto which the transparent ink 80 is discharged. The camera 62 also detects ultraviolet rays from the surface side of the transparent medium 50 onto which the transparent ink 80 is discharged. Thus, the inspection pattern printed on the transparent medium 50 with the transparent ink is photographed.

Subsequently, in step S1506, the coating apparatus 100 uses the inspection controller 40 to determine the discharge state of the heads 11 on the basis of a pattern of the ultraviolet rays 63 detected by the camera 62 (determination process).

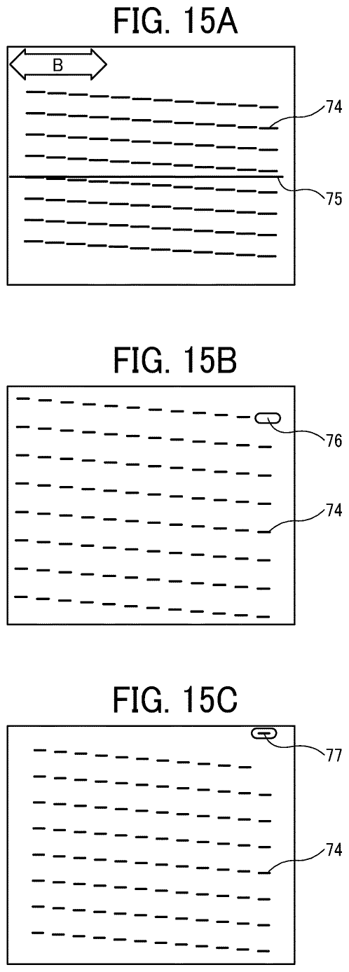

FIGS. 15A to 15C are diagrams illustrating an example of the pattern of the ultraviolet rays 63 detected by the camera 62.

In a case where an abnormality occurs in the discharge state of the heads 11, for example, the discharge pattern 75 may be constantly detected as illustrated in FIG. 15A. Unlike the normal discharge pattern 74, the constant discharge pattern 75 constantly discharges liquid in a printing direction B. Constant discharge may be determined by calculating the surface area of the constant discharge pattern 75 and comparing the surface area with the surface area of the normal discharge pattern 74.

In a case where an abnormality occurs in the discharge state of the heads 11, for example, as illustrated in FIG. 15B, a non-discharge pattern 76 may be detected. The non-discharge pattern 76 is different from the normal discharge pattern 74 in that liquid is not discharged. Non-discharge may be determined by calculating the surface area of the discharge pattern 75 at all times and comparing the surface area with the surface area of the normal discharge pattern 74.

In a case where an abnormality occurs in the discharge state of the heads 11, a discharge bend pattern 77 may be detected as illustrated in FIG. 15C, for example. The discharge bend pattern 77 exists in a position bent relative to the arrangement of the normal discharge pattern 74. To determine a discharge bend, model data for a bend-less discharge pattern 74 having less bending is acquired, and the center-of-gravity of the model data is compared with the center-of-gravity of the discharge bend pattern 77 to measure the bend amount of the pattern. In a case where the bend amount exceeds a prescribed value, it is determined that there is the discharge bend.

In a case where it is determined in step S1506 that the discharge state of the heads 11 is normal, the coating apparatus 100 performs the coating illustrated in FIG. 7 in step S1507.

In addition, in a case where it is determined in step S1506 that the discharge state of the heads 11 is non-discharge or discharge bending, the coating apparatus 100 uses the inspection controller 40 to determine that an abnormality has occurred in the discharge state of the heads 11 and returns to the processing in step S1502. The inspection controller 40 then increases, by one, the number of instances of cleaning of the heads 11 by the maintenance mechanism 15, and confirms whether the increased number of instances of cleaning exceeds a predetermined number of instances. In a case where the increased number of instances of cleaning does not exceed the predetermined number of instances, a maintenance operation such as cleaning of the heads 11 by the maintenance mechanism 15 is performed in step S1503. At that time, the fact that the discharge state of the heads 11 is non-discharge or discharge bending may be outputted as a display on a display unit or the like.

In addition, in a case where it is determined in step S1506 that the discharge state of the heads 11 is constant discharge, the coating apparatus 100 uses the inspection controller 40 to determine that an abnormality has occurred in the discharge state of the heads 11, and stops the coating in step S1508. At that time, the fact that the discharge states of the heads 11 is constant discharge may be outputted as a display on a display unit or the like.

As described above, in the present embodiment, the state of liquid discharge from the heads 11 is inspected using the transparent ink by utilizing the property that the transparent ink does not transmit ultraviolet rays. Specifically, the transparent ink is discharged onto a transparent medium, and then ultraviolet rays is emitted from one surface side of the transparent medium, while ultraviolet rays is detected from the other surface side of the transparent medium. Then, the discharge states of the heads are determined on the basis of the ultraviolet rays detection result. As a result, it is possible to inspect the transparent ink discharge state that is not detected only by applying light, such as overcoat liquid discharged from the heads 11 so as to cover the coating region in order to protect the coating of the vehicle body. At this time, an easy and reliable determination is made by determining the discharge states of the heads on the basis of the detected ultraviolet rays pattern. For example, an easier and more reliable determination is made by calculating the surface area of the detected ultraviolet rays pattern to detect the constant discharge and non-discharge of ink of the heads. Furthermore, an easier and more reliable determination is made by calculating the center of gravity position of the detected ultraviolet rays pattern to detect the discharge bend of the ink of the heads.

The present embodiment was described by citing an example in which the inspection method according to the present embodiment is applied to the coating apparatus 100 that performs coating of the object 200. However, the inspection method according to the present embodiment is not limited to the coating apparatus 100 that performs coating of the object 200, as long as the apparatus discharges liquid from liquid discharging means. Furthermore, the inspection method is applicable to the coating apparatus 100 that performs coating of the object 200 and the apparatus that does not control the robot arms 13 and does not correct the coating position unlike the apparatus described above.

Although an embodiment has been described above, the present embodiment is not limited to the above embodiment. That is, various modifications and improvements are feasible within the scope of the present embodiment.

In the above-described embodiment, examples of the liquid discharged from the heads 11 other than during inspection include a solution, a suspension, or an emulsion that includes, for example, a solvent such as water or an organic solvent, a colorant such as a dye or pigment, a functional material such as a polymerizable compound, a resin, or a surfactant, a biocompatible material such as DNA, amino acid, protein, or calcium, or an edible material such as a natural colorant. Such a solution, a suspension, or an emulsion is used, for example, as inkjet ink, a surface treatment solution, a liquid for forming electronic element components, light-emitting element components, or electronic-circuit resist patterns, or as a material fluids for three-dimensional fabrication.

The object 200 signifies an object to which liquid adheres and is fixed, an object to which liquid adheres and which is permeated by the liquid, or the like. Examples of the “material to which liquid adheres” include recording media such as a car body, a building material, paper sheet, recording sheet, recording sheet of paper, film, and cloth, electronic components such as electronic substrate and piezoelectric elements, and media such as a powder layer, an organ model, and a testing cell. The “material to which liquid adheres” includes any material to which liquid adheres, unless particularly limited.

Each function of the embodiment may be implemented by one processing circuit or a plurality of processing circuits. Here, the term “processing circuit or circuitry” in the present specification includes a programmed processor to execute each function using software such as a processor implemented by an electronic circuit, and devices such as an application specific integrated circuit (ASIC), a digital signal processor (DSP), a field programmable gate array (FPGA), and conventional circuit components arranged to perform the functions described above.

Aspects of the present embodiment are, for example, as follows.

### Aspect 1

An inspection method for inspecting a state of liquid discharge from liquid discharging means, the inspection method comprising:
a discharge step of discharging a transparent ink from the liquid discharging means onto a transparent base material;
an emission step of emitting ultraviolet rays from one surface side of the base material;
a detection step of using detecting means for detecting ultraviolet rays to detect the ultraviolet rays from the other surface side of the base material; and
a determination step of determining a discharge state of the liquid discharging means on the basis of a detection result of the detection step.

### Aspect 2

The inspection method according to Aspect 1, wherein the other surface is a surface where the transparent ink is discharged from the liquid discharging means onto the base material.

### Aspect 3

The inspection method according to Aspect 1 or Aspect 2, wherein at least one surface of the base material has an uneven shape.

### Aspect 4

The inspection method according to any one of Aspect 1 to Aspect 3, wherein, in the determination step, in a case where an ultraviolet rays pattern detected in the detection step is different from a pattern in which the liquid is discharged from the liquid discharging means, it is determined that the discharge state of the liquid discharging means is abnormal.

### Aspect 5

The inspection method according to Aspect 4, wherein, in the determination step, the surface area of the ultraviolet rays pattern detected in the detection step is calculated to detect constant discharge and non-discharge of liquid by the liquid discharging means.

### Aspect 6

The inspection method according to Aspect 4, wherein, in the determination step, a center-of-gravity position of the ultraviolet rays pattern detected in the detection step is calculated to detect a liquid discharge bend of the liquid discharging means.

### Aspect 7

The inspection method according to any one of Aspect 1 to Aspect 6, wherein the transparent ink is an ink including a resin that absorbs light of wavelengths of 200 through 400 nm.

### Aspect 8

A coating apparatus configured to perform coating by discharging liquid from liquid discharging means,
the liquid discharging means discharging a transparent ink onto a transparent base material, the coating apparatus comprising:
emitting means for emitting the ultraviolet rays from one surface side of the base material;
detecting means for detecting ultraviolet rays and detecting the ultraviolet rays from the other surface side of the base material; and
determining means for determining a discharge state of the liquid discharging means on the basis of a detection result of the detecting means.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

This patent application is based on International Application No. PCT/IB2024/054168, filed Apr. 30, 2024, which claims priority to Japanese Patent Application No. 2023-079432, filed on May 12, 2023, in the Japan Patent Office, the entire disclosure of each are hereby incorporated by reference herein.

### REFERENCE SIGNS LIST

11, 11Y, 11M, 11C, 11K head
11-1, 11-2, 11-3, 11-4 head
12, 12-1, 12-2, 12-3, 12-4 detector
13, 13-1, 13-2, 13-3, 13-4 robot arm
14 supply mechanism
15 maintenance mechanism
20 controller
21 input unit
22 acquisition unit
23 generator
24 corrector
25 discharge controller
26 supply controller
27 maintenance controller
28 movement controller
29 output unit
31 CPU
32 ROM
33 RAM
34 HDD/SSD
35 device coupling I/F
36 communication I/F
40 inspection controller
50 transparent medium
51 uneven shape
60 inspection mechanism
61 ultraviolet light source
62 camera
63 ultraviolet rays
71, 71a, 71b adhesion region
72, 72a, 72b non-adhesion region
73a main head portion
73b small head portion
74 discharge pattern
75 constant discharge pattern
76 non-discharge pattern
77 discharge bend pattern
80 transparent ink
100 coating apparatus
110 housing
111 supply port
112 collection port
113 connector
200 object
211 coating range
230 compressor
311 nozzle
321 nozzle plate
322 channel
324 piezoelectric element
325 liquid
330Y, 330M, 330C, 330K liquid tank
331 pipe
332 air regulator
333 tube
340 discharge module
C1 discharge control signal
C2 supply control signal
C3 maintenance control signal
C4 movement control signal
D shape data
E feature amount information
K1 object information
K2 coating color information
S system bus
S1 plane
T1 relative movement path information
T2 corrected path information

### CITATION LIST

### Patent Literature

[PTL 1] Japanese Patent No. 4561296

1. An inspection method comprising:
discharging a transparent ink onto a transparent substrate;
emitting ultraviolet rays from a first surface of the transparent substrate;
detecting ultraviolet rays transmitted through the transparent substrate, from a second surface opposite to the first surface of the transparent substrate; and
determining a discharge state of the discharging based on the detecting of the ultraviolet rays.

2. The inspection method according to claim 1, wherein:
the discharging discharges the transparent ink onto the second surface of the transparent substrate.

3. The inspection method according to claim 1, wherein:
at least one of the first surface or the second surface has an uneven shape.

4. The inspection method according to claim 1, wherein:
the discharging the transparent ink onto the transparent substrate to form a pattern on the transparent substrate;
the detecting detects the pattern of the ultraviolet rays transmitted through the transparent substrate; and
the determining determines that the discharge state is abnormal when the pattern of the ultraviolet rays detected by the detecting is different from the pattern of the transparent ink on the transparent substrate.

5. The inspection method according to claim 4, wherein the determining:
calculates a surface area of the pattern of the ultraviolet rays detected by the detecting; and
determining that there is constant discharge or non-discharge of the discharging.

6. The inspection method according to claim 4, wherein the determining:
calculates a position of a center-of-gravity of the pattern of the ultraviolet rays detected by the detecting;
compares the center-of-gravity of the pattern of the ultraviolet rays with a center-of-gravity of the pattern of the transparent ink discharged normally on the transparent substrate to measure a bend amount of the pattern; and
determines a bend in the discharging based on the bend amount.

7. The inspection method according to claim 1, wherein;
the discharging discharges the transparent ink including a resin that absorbs light of wavelengths of 200 through 400 nm.

8. A coating apparatus comprising:
a transparent substrate;
a head to:
discharge a liquid onto an object to coat the object; and
discharge a transparent ink onto the transparent substrate;
an emitter to emitting ultraviolet rays from a first surface of the transparent substrate;
a detector to detect the ultraviolet rays transmitted through the transparent substrate, from a second surface opposite to the first surface of the transparent substrate; and
control circuitry configured to determine a discharge state of the head based on the ultraviolet rays detected by the detector.
